(19) United States
(12) Patent Application Publication
(10) Pub. No.: US 2020/0192818 A1
(43) Pub. Date: Jun. 18, 2020

(54) TRANSLATION LOOKASIDE BUFFER CACHE MARKER SCHEME FOR EMULATING SINGLE-CYCLE PAGE TABLE ENTRY INVALIDATION

(71) Applicant: QUALCOMM INCORPORATED, San Diego, CA (US)

(72) Inventors: Vipul Gandhi, San Diego, CA (US); Karthik Nagasubramanian, Bangalore (IN); Kumar Saket, Bangalore (IN); Bharatvishnu Raman, Bangalore (IN); Felix Varghese, Bangalore (IN)

(21) Appl. No.: 16/224,328

(22) Filed: Dec. 18, 2018

(51) Int. Cl. G06F 12/1045; G06F 12/0891

(52) U.S. Cl. CPC G06F 12/1045; G06F 2212/684; G06F 2212/683; G06F 12/0891

(57) ABSTRACT

A system and method for emulating single-cycle translation lookaside buffer invalidation are described. One embodiment of a method comprises defining a translation lookaside buffer (TLB) cache marking variable comprising a first marker value and a second marker value. A context bank marker associated with a translation context bank is initiated with one of the first marker value and the second marker value. A TLB cache entry table specifies whether each of a plurality of TLB cache entries associated with the translation context bank has a corresponding entry marker set to the first marker value or the second marker value. In response to a TLB invalidate command associated with the translation context bank, the context bank marker is changed from the one of the first marker value and the second marker value to the other of the first marker value and the second marker value prior to initiating TLB invalidation.

### DESCRIPTION OF THE RELATED ART

Portable computing devices (e.g., cellular telephones, smart phones, tablet computers, portable game consoles, wearable devices, and other battery-powered devices), Internet of things (IoT) devices (e.g., smart home appliances, automotive and other embedded systems), and other computing devices continue to offer an ever-expanding array of features and services, and provide users with unprecedented levels of access to information, resources, and communications. To keep pace with these service enhancements, such devices have become more powerful and more complex. Smart computing devices now commonly include a system on chip (SoC) comprising an application processor and one or more non-application SoC processing devices embedded on a single substrate. The application processor and the non-application SoC processing devices comprise memory clients that read data from and store data in a system memory.

The application processor may include a memory management unit (MMU) and the non-application SoC processing device(s) may including system MMUs configured to perform processing operations with reference to virtual memory addresses. In the process of supporting various virtual memory maintenance or optimization operations (e.g., changing address mapping, page permissions, etc.), stale page table entries in a translation lookaside buffer (TLB) cache may need to be invalidated. While invalidation of stale page table entries is a common process in systems with SMMUs, it comes at the cost of increased translation latencies during and after invalidation, particularly for real-time sensitive memory clients, such as, for example, a display processor and a camera digital signal processor. In complex SoCs, the amount of time to perform the TLB invalidation process is relatively long due to larger TLB cache sizes. For such systems, the invalidation duration parameter may be critical for real-time clients, which may not be able to sustain high translation latencies for longer duration that may eventually cause display overrun or camera overflow.

Accordingly, there is a need in the art for improved systems for performing page table entry invalidation in systems with larger TLB cache sizes without unnecessarily increasing hardware cost.

### SUMMARY OF THE DISCLOSURE

Systems, methods, and computer programs are disclosed for emulating single cycle translation lookaside buffer invalidation. One embodiment of a method comprises defining a translation lookaside buffer (TLB) cache marking variable comprising a first marker value and a second marker value. A context bank marker associated with a translation context bank is initiated with one of the first marker value and the second marker value. A TLB cache entry table is stored in a memory. The TLB cache entry table specifies whether each of a plurality of TLB cache entries associated with the translation context bank has a corresponding entry marker set to the first marker value or the second marker value. In response to a TLB invalidate command associated with the translation context bank, the context bank marker is changed from the one of the first marker value and the second marker value to the other of the first marker value and the second marker value prior to initiating TLB invalidation. During the TLB invalidation associated with the translation context bank, the TLB cache entry table is accessed to determine whether each of the plurality of TLB cache entries has the corresponding entry marker set to the first marker value or the second marker value. If the entry marker for the TLB cache entry is set to a same value as the context bank marker, the method bypasses invalidation for the TLB cache entry and changes the entry marker to a different value than the context bank marker. If the entry marker for the TLB cache entry is set to a different value than the context bank marker, the method determines that the TLB cache entry comprises a stale entry and invalidates the TLB cache entry.

Another embodiment of a system comprises an application processor, one or more memory clients, and a single-cycle translation lookaside buffer (TLB) invalidation emulator component. The application processor comprises a memory management unit (MMU) having a first TLB. The one or more memory clients have a corresponding system memory management unit (SMMU) comprising a corresponding second TLB. The single-cycle TLB invalidation emulator component is in communication with the MMU and the SMMU, and comprises logic configured to: define a translation lookaside buffer (TLB) cache marking variable comprising a first marker value and a second marker value; initiate a context bank marker associated with a translation context bank with one of the first marker value and the second marker value; store in a memory a TLB cache entry table specifying whether each of a plurality of TLB cache entries associated with the translation context bank has a corresponding entry marker set to the first marker value or the second marker value; in response to a TLB invalidate command associated with the translation context bank, change the context bank marker from the one of the first marker value and the second marker value to the other of the first marker value and the second marker value prior to initiating TLB invalidation; and during the TLB invalidation associated with the translation context bank; access the TLB cache entry table to determine whether each of the plurality of TLB cache entries has the corresponding entry marker set to the first marker value or the second marker value; if the entry marker for the TLB cache entry is set to a same value as the context bank marker, bypass invalidation for the TLB cache entry and change the entry marker to a different value than the context bank marker; and if the entry marker for the TLB cache entry is set to a different value than the context bank marker, determine that the TLB cache entry comprises a stale entry and invalidate the TLB cache entry.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for implementing a translation lookaside buffer (TLB) cache marker scheme for emulating single-cycle page table entry invalidation.

FIG. 2 illustrates an embodiment of a TLB cache marker scheme implemented with one or more context banks and a TLB cache entry marker table.

FIG. 3 is flowchart illustrating an embodiment of a method for emulating single-cycle TLB cache invalidation in the system of FIG. 1.

FIG. 4 is a timeline illustrating an exemplary method for implementing the TLB cache marker scheme.

FIG. 5 is a block diagram of an embodiment of a portable computing device that may incorporate the systems and methods for emulating single-cycle TLB cache invalidation via the TLB cache marker scheme.

### DETAILED DESCRIPTION

The word “exemplary” is used herein to mean “serving as an example, instance, or illustration.” Any aspect described herein as “exemplary” is not necessarily to be construed as preferred or advantageous over other aspects.

The terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes, such as in accordance with a signal having one or more data packets (e.g., data from one component interacting with another component in a local system, distributed system, and/or across a network such as the Internet with other systems by way of the signal).

The term “application” or “image” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

The term “task” may include a process, a thread, or any other unit of execution in a device.

The term “virtual memory” refers to the abstraction of the actual physical memory from the application or image that is referencing the memory. A translation or mapping may be used to convert a virtual memory address to a physical memory address. The mapping may be as simple as 1-to-1 (e.g., physical address equals virtual address), moderately complex (e.g., a physical address equals a constant offset from the virtual address), or the mapping may be complex (e.g., every 4 KB page mapped uniquely). The mapping may be static (e.g., performed once at startup), or the mapping may be dynamic (e.g., continuously evolving as memory is allocated and freed).

In this description, the terms “communication device,” “wireless device,” “wireless telephone”, “wireless communication device,” and “wireless handset” are used interchangeably. With the advent of third generation (“3G”), fourth generation (“4G”), and fifth generation (“5G”) wireless technology, greater bandwidth availability has enabled more portable communication devices with a greater variety of wireless capabilities. Therefore, the term “portable communication device” or “portable computing device” may refer to cellular telephones, smart phones, tablet computers, portable game consoles, wearable devices, Internet of things (IoT) devices (e.g., smart home appliances, automotive and other embedded systems), or other battery-powered computing devices.

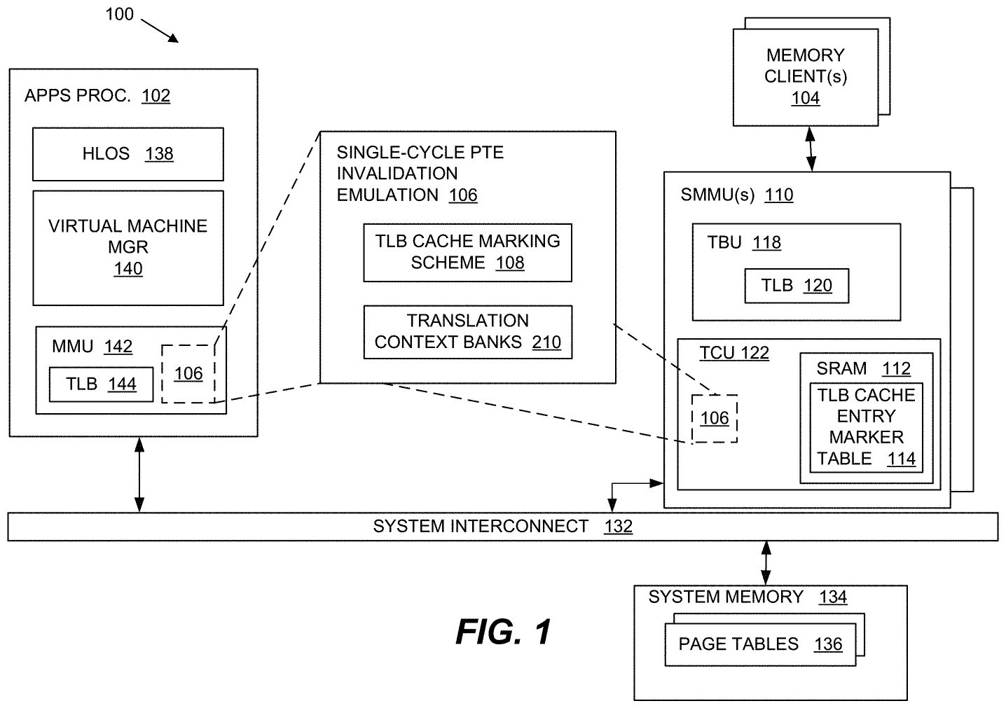

FIG. 1 illustrates an embodiment of a system 100 for emulating single-cycle translation lookaside buffer (TLB) invalidation via a TLB cache marking scheme 108. The system 100 comprises a plurality of processing devices electrically coupled to a system memory 134 via a system interconnect 132. The system memory 134 may include a system cache (not shown). It should be appreciated that in certain embodiments the system memory 132 may comprise one or more dynamic random access memory (DRAM) modules electrically coupled to a system on chip (SoC). System interconnect 132 may comprise one or more busses and associated logic for connecting the processing devices, memory management units, and other elements of the system 100.

As illustrated in FIG. 1, one of the SoC processing devices comprises an application processor 102. It should be appreciated that the application processor 102 comprises a specially-configured processor designed to support applications running in a mobile operating system environment. As known in the art, a mobile application processor comprises a self-contained operating environment that delivers the system capabilities for supporting a portable computing device's applications, including, for example, memory management, graphics processing, etc. As illustrated in FIG. 1, application processor 102 may execute a high-level operating system (HLOS) 138 and any applications software. Application processor 102 may comprise a multi-core central processing unit (CPU) having one or more CPU(s), graphics processing unit(s) (GPU(s)), etc.

It should be further appreciated that application processor 102 may be independent from one or more additional processing devices residing on the SoC that may access system memory 134. In this regard, the independent SoC processing device(s) may be referred to as “non-application” processing device(s) or memory client(s) because they are distinct from application processor 102. In the embodiment of FIG. 1, the SoC further comprises one or more memory clients 104. Memory clients 104 may comprise any type of processing device, processor, digital signal processor (DSP), etc. Examples of non-application processing devices include, but are not limited to, a display processing unit, a video processing unit, a camera processing unit, a cryptographic engine, a general purpose direct memory access engine, etc.

Application processor 102 and non-application SoC processing device(s) (e.g., memory clients 104) may be configured to perform processing operations with reference to virtual memory addresses. In this regard, application processor 102 comprises a memory management unit (MMU) 142 and each non-application SoC processing device may comprise (or may be electrically coupled to) a subsystem MMU. In the embodiment of FIG. 1, memory clients 104 may comprise SMMU 110. MMU 142 and SMMU(s) 110 are configured to translate the virtual memory addresses used by the respective processing devices into physical memory addresses used by the system memory 134 with reference to page tables 136 that are stored in the system memory 134.

MMU 142 comprises logic (e.g., hardware, software, or a combination thereof) that performs address translation for application processor 102. Although for purposes of clarity MMU 142 is depicted in FIG. 1 as being included in application processor 142, MMU 142 may be externally coupled to application processor 102. SMMU(s) 110 provide address translation services for upstream device traffic in much the same way that the application processor MMU 142 translates addresses for processor memory accesses.

As illustrated in FIG. 1, each SMMU 110 comprises a corresponding translation buffer unit (TBU) 118 and a translation control unit (TCU) 122. As known in the art, TBU 118 stores recent translations of virtual memory to physical memory in, for example, a translation look-aside buffer (TLB) 120. If a virtual-to-physical address translation is not available in TBU 118, TCU 122 may perform a page table walk executed by a page table walker module. In this regard, the main functions of the TCU include address translation, memory protection, and attribute control. Address translation is a method by which an input address in a virtual address space is translated to an output address in a physical address space. Translation information is stored in page tables 136 that the SMMU 110 references to perform address translation. There are two main benefits of address translation. First, address translation allows memory client(s) 104 to address a large physical address space. For example, a 32-bit processing device (i.e., a device capable of referencing 2³² address locations) can have its addresses translated such that memory clients 104 may reference a larger address space, such as a 36-bit address space or a 40-bit address space. Second, address translation allows processing devices to have a contiguous view of buffers allocated in memory, despite the fact that memory buffers are typically fragmented, physically non-contiguous, and scattered across the physical memory space.

Page tables 136 contain information necessary to perform address translation for a range of input addresses. Although not shown in FIG. 1 for purposes of clarity, page tables 136 may include a plurality of tables comprising page table entries (PTE). It should be appreciated that the page tables 136 may include a set of sub-tables arranged in a multi-level “tree” structure. Each sub-table may be indexed with a sub-segment of the input address. Each sub-table may include translation table descriptors. There are three base types of descriptors: (1) an invalid descriptor, which contains no valid information; (2) table descriptors, which contain a base address to the next level sub-table and may contain translation information (such as access permission) that is relevant to all sub-sequent descriptors encountered during the walk; and (3) block descriptors, which contain a base output address that is used to compute the final output address and attributes/permissions relating to block descriptors.

The process of traversing page tables 136 to perform address translation is known as a “page table walk.” A page table walk is accomplished by using a sub-segment of an input address to index into the translation sub-table, and finding the next address until a block descriptor is encountered. A page table walk comprises one or more “steps.” Each “step” of a page table walk involves: (1) an access to a page table 136, which includes reading (and potentially updating) it; and (2) updating the translation state, which includes (but is not limited to) computing the next address to be referenced. Each step depends on the results from the previous step of the walk. For the first step, the address of the first page table entry that is accessed is a function of the translation table base address and a portion of the input address to be translated. For each subsequent step, the address of the page table entry accessed is a function of the page table entry from the previous step and a portion of the input address. In this manner, the page table walk may comprise two stages. A first stage may determine the intermediate physical address. A second stage may involve resolving data access permissions at the end of which the physical address is determined.

As further illustrated in FIG. 1, applications processor 102 may comprise a virtual machine manager 140 configured to manage a plurality of virtual machines. Virtual machine manager 140 may be configured to provide a virtual machine (VM) based security model. Virtual machine manager 140 may support a distributed virtual memory (DVM) system comprising different types of virtual machines: (1) headful virtual machines; and (2) headless virtual machines. Virtual machines in which code is executed by application processor 102 are referred to as “headful” or HLOS virtual machines. Virtual machines executed by non-application SoC processing devices (e.g., memory clients 104) are referred to as “headless” virtual machines. In headless virtual machines, no code runs on application processor 102. Instead, the code runs only on the non-application SoC processing device. The term “head” is used as an analogy for the application processor 102. Hence, if a virtual machine has a component running on application processor 102, it is considered a headful virtual machine. If a virtual machine is only running on non-application processors within SoC, then it is considered to be a headless virtual machine. Examples of a headless virtual machine may include, though not limited to, an audio virtual machine that runs on an audio processing unit or a multimedia content protection virtual machine that runs on the display processing unit and video processing unit.

As further illustrated in FIG. 1, the system 100 comprises a sub-system for emulating single-cycle invalidation behavior for one or more translation context banks 210 (e.g., single-cycle page table entry (PTE) invalidation emulation component 106) using a specially-configured TLB cache marking scheme 108. Single-cycle PTE invalidation emulation component 106 may be integrated in one or more of MMU 142 and SMMU(s) 110. In an embodiment, single-cycle PTE invalidation emulation component 106 resides in MMU 142 with SMMU(s) 110 accessing the functionality by communicating with MMU 142. In other embodiments, SMMU 110 may be configured to support a separate single-cycle PTE invalidation emulation component 106.

It should be appreciated that single-cycle PTE invalidation emulation provided via TLB cache marking scheme 108 may advantageously provide the benefits of single-cycle invalidation behavior for systems employing larger TLB cache sizes and real-time sensitive memory clients (e.g., display, camera, etc.) without unnecessarily increasing hardware costs.

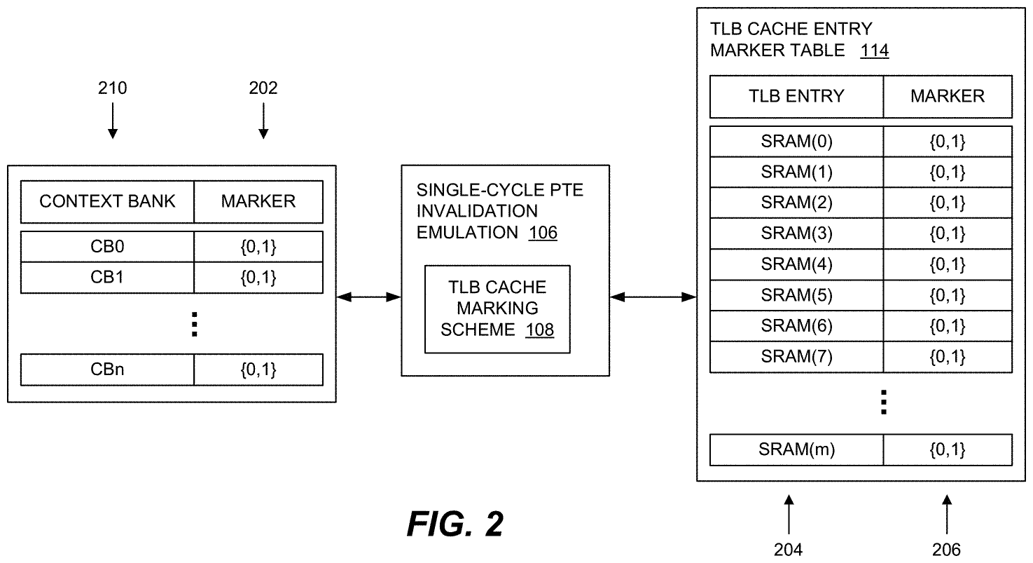

As illustrated in FIG. 2, in an exemplary embodiment, the TLB cache marking scheme 108 may be implemented with a 1-bit marker scheme defining a first marker value (0) and a second marker value (1). It should be appreciated, however, that multi-bit marking schemes may also be implemented. Referring to FIG. 2, each of a plurality of translation context banks 110 may have a corresponding context bank marker 202 selectively set to either the first marker value or the second marker value (i.e., {0, 1}). Each translation context bank 210 defines a virtual space which is isolated with other virtual space associated with a client (i.e. a client such as, but not limited to, a display, a camera processor, etc.).

System 100 further comprises a memory (e.g., static random access memory (SRAM) 112) for storing a TLB cache entry table 114. As further illustrated in the embodiment of FIG. 2, TLB cache entry table 114 maps each of a plurality of TLB cache entries (column 204) associated with a particular translation context bank 210 (e.g., CB0, CB1 . . . CBn) to a corresponding entry marker (column 206) selectively set to either the first marker value or the second marker value (i.e., {0, 1}).

As mentioned above, conventional TLB invalidation may take multiple clock cycles to complete because the hardware has to go through each index of the TLB cache for context bank 210 and virtual address values, and then invalidate if there is a match. For complex systems, the TLB cache size may be relatively large (e.g., 8K indexes). For example, in a 4-way associative cache, the maximum and minimum invalidation duration may be in the range of 4K-6K clock cycles. During the duration of 6K cycles of context bank 210 (CB) based invalidation, the content of the TLB cache remains unusable for the corresponding context bank 210 in order to avoid a “hit” to the stale entries that are yet to be invalidated. Furthermore, any update request to the same context bank 210 may be dropped during the entire 6K clock cycle. The TLB cache warmup with new valid entries may start only after the completion of invalidation, which may cause performance degradation for real-time clients (e.g., display, camera) because they may have started sending traffic based on new page tables much earlier. As a result, most of the traffic from these clients may get a “miss” even though they could have benefited from the “hit” of the newly updated entries. Conventional single-cycle invalidation may address these issues, but they come at the expense of additional hardware cost because the tag for each index of the TLB cache must be “flopped” separately.

System 100 combines single-cycle PTE invalidation emulation via TLB cache marking scheme 108 and TLB cache entry marker table 114 to advantageously provide the benefits of single-cycle invalidation behavior for systems employing larger TLB cache sizes and real-time sensitive memory clients (e.g., display, camera, etc.) without unnecessarily increasing hardware costs. The 1-bit marker scheme illustrated in FIG. 2 provides various performance benefits and hardware area benefits. For example, by storing the entry markers (e.g., TLB cache entry marker table 114) in SRAM 110, the system 100 may save the hardware area cost of additional flops (N*Tag Width), where N equals the total number of TLB cache entries. The 1-bit marker scheme illustrated in FIG. 2 only adds 1-bit per cache index for the entry markers (column 206) in TLB cache entry marker table 114 stored in SRAM 110. By contrast, assuming a 16 KB cache size with a tag width of 26 bits, conventional single-cycle invalidation require significantly more hardware cost/area (16K*26 flops/registers).

Furthermore, it should be appreciated that single-cycle PTE invalidation emulation via TLB cache marking scheme 108 and TLB cache entry marker table 114 advantageously provides various performance benefits. For example, as described below in more detail, the TLC cache marking scheme 108 allows TCU cache updates and look-ups while invalidation is in progress for the same translation context bank 210 and ignores invalidation for any newly updated entries in TCU cache. This will ensure that TCU cache is usable for both updates and look-ups even during self-invalidation. In addition, interleaved TBU traffic may be advantageously processed by, for example, data sharing at the TCU cache during self-invalidation, which may avoid redundant page table walks for a second TBU look-up. It should be further appreciated that the managed values of the context bank marker (column 202) and the associated entry markers (column 206) may be used to distinguish between new and old/stale entries in cache. In response to a TLB invalidation command, the context bank marker value may be toggled to a different value prior to initiating invalidation. In this regard, any page table walk in progress before the start of invalidation may not get updated in TBU and TCU cache. Any look-up of newly updated entries post-invalidation start may get a “hit” during TCU cache look-up due to the modified context bank marker value. During invalidation, only entries matching the prior context bank marker value will get invalidated and all newly updated entries will not get invalidated.

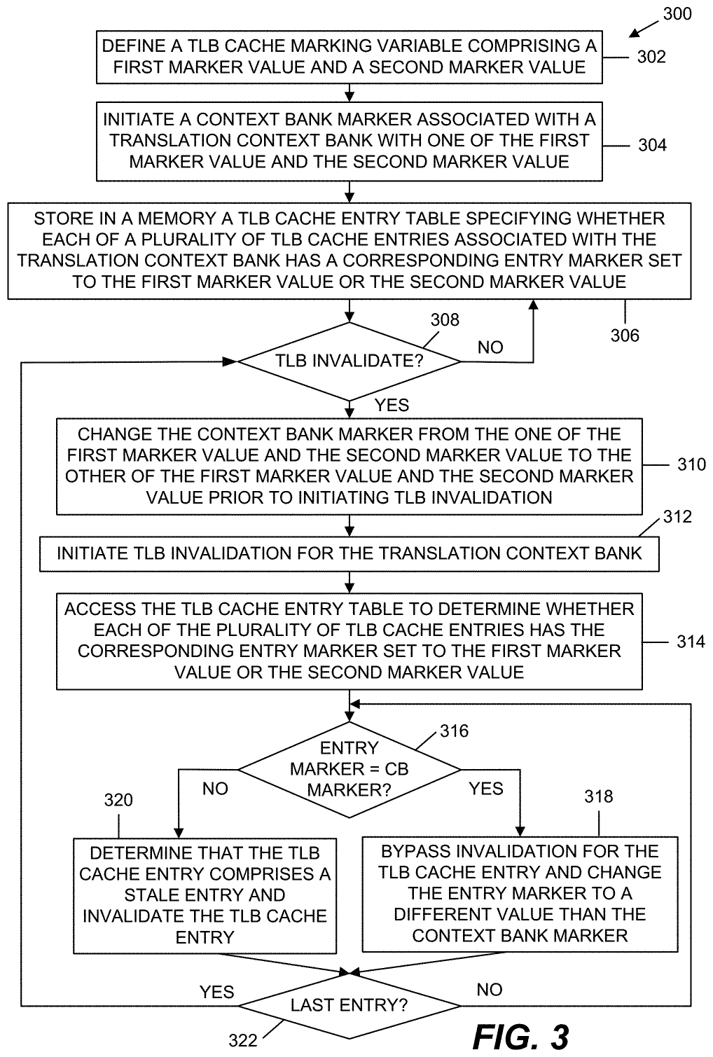

Having generally described the operation of the TLB cache marking scheme 108, an exemplary method 300 will be described with reference to FIG. 3. At block 302, the TLB cache marking scheme 108 is predefined. In an embodiment, a TLB cache marking variable may be defined, which comprises a first marker value and a second marker value. It should be appreciated that the TLB cache marking variable may be implemented as a 1-bit scheme or a multi-bit scheme on a case-by-case basis. At block 304, a context bank marker 202 associated with a translation context bank 210 (e.g., CB0) may be initiated with one of the first marker value and the second marker value. At block 306, the TLB cache entry table 114 may be stored in memory (e.g., SRAM 110) with each of a plurality of TLB cache entries (column 204) associated with the translation context bank 210 (e.g., CB0) having an entry marker (column 206) set to the first marker value or the second marker value.

In response to a TLB invalidate command associated with the translation context bank CB0 (decision block 308), the corresponding context bank marker is changed (block 310) from the one of the first marker value and the second marker value to the other of the first marker value and the second marker value prior to initiating TLB invalidation. For example, if prior to receiving a TLB invalidate command the CB0 has an associated context bank marker with the first marker value (0), the context marker may be toggled (or otherwise changed in the event of a multi-bit scheme) to the second marker value (1) before initiating TLB invalidation. At block 312, TLB invalidation may be initiated. During TLB invalidation associated with the context bank 210 (C0), at block 314, TLB cache entry marker table 114 may be accessed to determine whether each of the plurality of TLB cache entries associated with context bank 210 (C0) has the corresponding entry marker set to the first marker value or the second marker value. At decision block 316, the system 100 determines whether the entry marker for each TLB cache entry has the same value as the current context bank marker (which was toggled/changed upon initiation of the TLB invalidation in block 310). If the entry marker for the TLB cache entry is set to a same value as the current context bank marker, the method 300 bypasses invalidation (block 318) for the TLB cache entry and changes the entry marker to a different value than the current context bank marker. If the entry marker for the TLB cache entry is set to a different value than the current context bank marker, the method 300 determines that the TLB cache entry comprises a stale entry and invalidates the TLB cache entry (block 320). As illustrated at decision block 322, upon a last TLB entry being processed, flow may return to, for example, block 306 and/or 308 for additional updates to the TLB cache entry marker table 114.

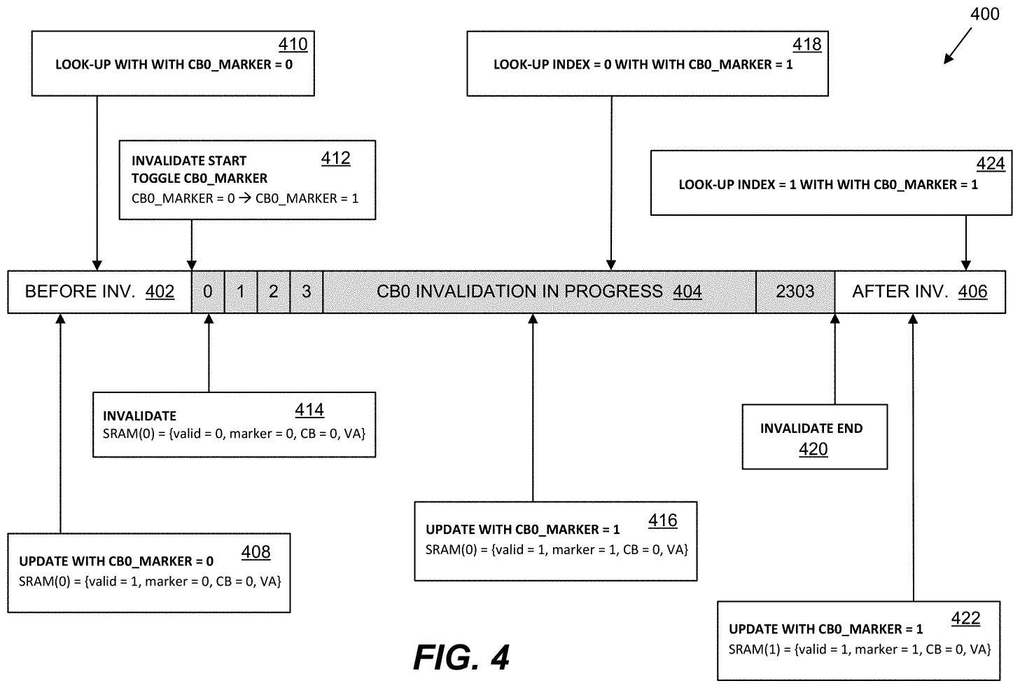

FIG. 4 is a timeline 400 illustrating another embodiment of a method for implementing the TLB cache marker scheme 108 for a translation context bank (CB0). Timing window 402 comprises a period of time prior to the initiation of invalidation for translation context bank CB0. CB0 invalidation is in progress during the timing window 404 represented with grey blocks. Timing window 406 comprises a period of time after CB0 invalidation has completed. Timeline 400 illustrates various performance benefits provided by the TLB cache marker scheme 108 with reference to exemplary commands and associated processes occurring during timing windows 402, 404, and 406. The context bank marker for CB0 may be initiated with the value CB0_marker=0. During timing window 402 prior to CB0 invalidation, a cache update (block 408) may be performed to a first cache entry having an associated entry marker stored in SRAM 110 at location SRAM(0). The first cache entry has the following values: (valid=1, entry_marker=0, CB=0, virtual address). After the cache update and still prior to CB0 invalidation, a lookup operation (block 410) may be performed with CB0_marker=0.

At block 412, a CB0 invalidation command may be initiated to begin CB0 invalidation. In response to the CB0 invalidation command, the context bank marker value may be toggled from CB0_marker=0 to CB0_marker=1. At block 414, the first cache entry may be invalidated because the entry marker has a value (entry_marker=0) and the context bank marker has a different value (CB0_marker=1). CB0 invalidation may progress through timing window 404 for additional cache entries. During CB0 invalidation, further cache updates (block 416) and look-ups (block 418) may be performed. At block 416, a cache update may be performed to the first cache entry with CB0_marker=1. The updated first cache entry has the following values: (valid=1, entry_marker=1, CB=0, virtual address). At block 418, a lookup operation to an index=0 may be performed with CB0_marker=1. Upon completion of CB0 invalidation (block 420), the context marker has the value CB0_marker=1. After CB0 invalidation during timing window 406, further cache updates (block 422) and look-ups (block 424) may be performed. At block 422, a look-up to index=1 may be performed with CB0_marker=1. At block 424, a cache update may be performed to a second cache entry having an associated entry marker stored in SRAM 110 at location SRAM(1). After the cache update, the second cache entry has the following value: {valid=1, entry_marker=1, CB=0, virtual address).

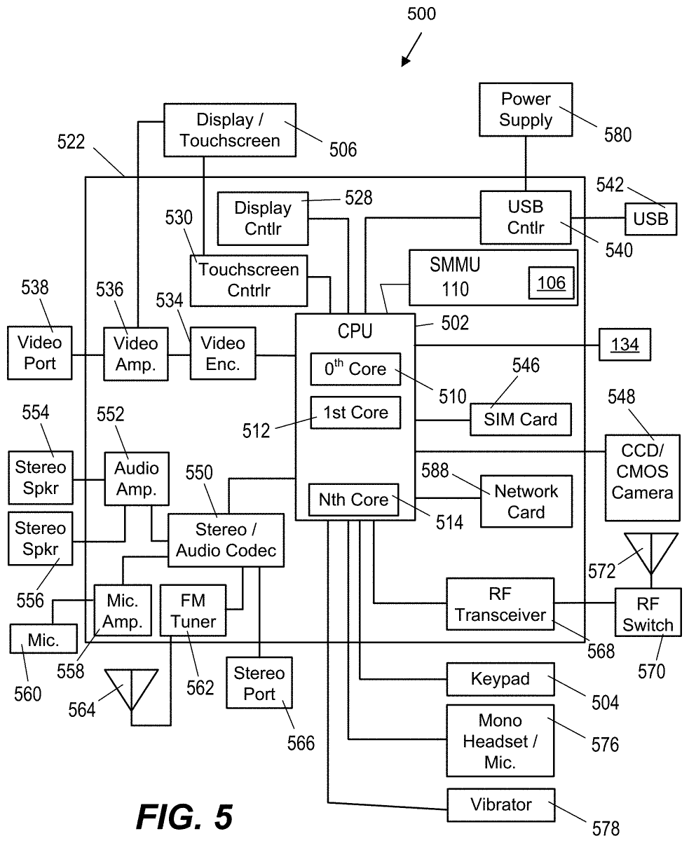

FIG. 5 illustrates an embodiment in which system 100 of FIG. 1 is incorporated in an exemplary portable computing device (PCD) 500. PCD 500 may comprise a smart phone, a tablet computer, or a wearable device (e.g., a smart watch, a fitness device, etc.). It will be readily appreciated that certain components of the system 100 are included on the SoC 522 (e.g., system interconnect 132, application processor 102, memory clients 104, SMMUs 110, 112, and 114, TLB cache entry marker table 114, and single-cycle PTE invalidation emulation module 106) while other components (e.g., the system memory 134) may be external components coupled to the SoC 522. The SoC 522 may include a multicore CPU 502. The multicore CPU 502 may include a zeroth core 510, a first core 512, and an Nth core 514. One of the cores may comprise the application processor 102 with one or more of the others comprising a CPU, a graphics processing unit (GPU), etc.

A display controller 528 and a touch screen controller 530 may be coupled to the CPU 502. In turn, the touch screen display 507 external to the on-chip system 522 may be coupled to the display controller 528 and the touch screen controller 530.

FIG. 5 further shows that a video encoder 534, e.g., a phase alternating line (PAL) encoder, a sequential color a memoire (SECAM) encoder, or a national television system(s) committee (NTSC) encoder, is coupled to the multicore CPU 502. Further, a video amplifier 536 is coupled to the video encoder 534 and the touch screen display 506. Also, a video port 538 is coupled to the video amplifier 536. As shown in FIG. 5, a universal serial bus (USB) controller 540 is coupled to the multicore CPU 502. Also, a USB port 542 is coupled to the USB controller 540. A subscriber identity module (SIM) card 546 may also be coupled to the multicore CPU 502.

Further, as shown in FIG. 5, a digital camera 548 may be coupled to the multicore CPU 502. In an exemplary aspect, the digital camera 548 is a charge-coupled device (CCD) camera or a complementary metal-oxide semiconductor (CMOS) camera.

As further illustrated in FIG. 5, a stereo audio coder-decoder (CODEC) 550 may be coupled to the multicore CPU 502. Moreover, an audio amplifier 552 may be coupled to the stereo audio CODEC 550. In an exemplary aspect, a first stereo speaker 554 and a second stereo speaker 556 are coupled to the audio amplifier 552. FIG. 5 shows that a microphone amplifier 558 may be also coupled to the stereo audio CODEC 650. Additionally, a microphone 560 may be coupled to the microphone amplifier 558. In a particular aspect, a frequency modulation (FM) radio tuner 562 may be coupled to the stereo audio CODEC 550. Also, an FM antenna 564 is coupled to the FM radio tuner 562. Further, stereo headphones 566 may be coupled to the stereo audio CODEC 550.

FIG. 5 further illustrates that a radio frequency (RF) transceiver 568 may be coupled to the multicore CPU 502. An RF switch 570 may be coupled to the RF transceiver 568 and an RF antenna 572. A keypad 504 may be coupled to the multicore CPU 502. Also, a mono headset with a microphone 576 may be coupled to the multicore CPU 502. Further, a vibrator device 578 may be coupled to the multicore CPU 502.

FIG. 5 also shows that a power supply 580 may be coupled to the on-chip system 522. In a particular aspect, the power supply 580 is a direct current (DC) power supply that provides power to the various components of the PCD 500 that require power. Further, in a particular aspect, the power supply is a rechargeable DC battery or a DC power supply that is derived from an alternating current (AC) to DC transformer that is connected to an AC power source.

FIG. 5 further indicates that the PCD 500 may also include a network card 588 that may be used to access a data network, e.g., a local area network, a personal area network, or any other network. The network card 588 may be a Bluetooth network card, a WiFi network card, a personal area network (PAN) card, a personal area network ultra-low-power technology (PeANUT) network card, a television/cable/satellite tuner, or any other network card well known in the art. Further, the network card 588 may be incorporated into a chip, i.e., the network card 588 may be a full solution in a chip, and may not be a separate network card 588.

As depicted in FIG. 5, the touch screen display 506, the video port 538, the USB port 542, the camera 548, the first stereo speaker 554, the second stereo speaker 556, the microphone 560, the FM antenna 564, the stereo headphones 566, the RF switch 570, the RF antenna 572, the keypad 574, the mono headset 576, the vibrator 578, and the power supply 580 may be external to the on-chip system 522.

Alternative embodiments will become apparent to one of ordinary skill in the art to which the invention pertains without departing from its spirit and scope. Although selected aspects have been illustrated and described in detail, it will be understood that various substitutions and alterations may be made therein without departing from the spirit and scope of the present invention, as defined by the following claims.

What is claimed is:

1. A method for emulating single-cycle translation lookaside buffer invalidation, the method comprising:
defining a translation lookaside buffer (TLB) cache marking variable comprising a first marker value and a second marker value;
initiating a context bank marker associated with a translation context bank with one of the first marker value and the second marker value;
storing in a memory a TLB cache entry table specifying whether each of a plurality of TLB cache entries associated with the translation context bank has a corresponding entry marker set to the first marker value or the second marker value;
in response to a TLB invalidate command associated with the translation context bank, changing the context bank marker from the one of the first marker value and the second marker value to the other of the first marker value and the second marker value prior to initiating TLB invalidation; and
during the TLB invalidation associated with the translation context bank;
accessing the TLB cache entry table to determine whether each of the plurality of TLB cache entries has the corresponding entry marker set to the first marker value or the second marker value;
if the entry marker for the TLB cache entry is set to a same value as the context bank marker, bypass invalidation for the TLB cache entry and change the entry marker to a different value than the context bank marker; and
if the entry marker for the TLB cache entry is set to a different value than the context bank marker, determine that the TLB cache entry comprises a stale entry and invalidate the TLB cache entry.

2. The method of claim 1, wherein the memory storing the TLB cache entry table comprises a static random access memory (SRAM).

3. The method of claim 1, wherein the TLB cache marking variable comprising the first marker value and the second marker value is implemented with a 1-bit variable.

4. The method of claim 1, wherein the TLB invalidate command comprises one of a global TLB invalidate command and a context-specific TLB invalidate command identifying the translation context bank.

5. The method of claim 1, further comprising:
when the TLB invalidation associated with the translation context bank is not being performed, initiating a cache update command for one of the plurality of TLB cache entries;
in response to the cache update command, updating the one of the plurality of TLB cache entries; and
changing the entry marker for the one of the plurality of TLB cache entries to a same value as the context bank marker associated with the translation context bank.

6. The method of claim 1, further comprising:
during the TLB invalidation associated with the translation context bank, initiating a look-up command to one of the plurality of TLB cache entries; and
in response to the look-up command, declaring a cache hit if the entry marker for the one of the plurality of TLB cache entries is set to the same value as the context bank marker.

7. The method of claim 1, further comprising:
during the TLB invalidation associated with the translation context bank, initiating a look-up command to one of the plurality of TLB cache entries; and
in response to the look-up command, declaring a cache miss if the entry marker for the one of the plurality of TLB cache entries is set to the different value than the context bank marker.

8. A system for emulating single-cycle translation lookaside buffer invalidation, the method comprising:
means for defining a translation lookaside buffer (TLB) cache marking variable comprising a first marker value and a second marker value;
means for initiating a context bank marker associated with a translation context bank with one of the first marker value and the second marker value;
means for storing a TLB cache entry table specifying whether each of a plurality of TLB cache entries associated with the translation context bank has a corresponding entry marker set to the first marker value or the second marker value;
means for changing, in response to a TLB invalidate command associated with the translation context bank, the context bank marker from the one of the first marker value and the second marker value to the other of the first marker value and the second marker value prior to initiating TLB invalidation; and
means for accessing, during the TLB invalidation associated with the translation context bank, the TLB cache entry table to determine whether each of the plurality of TLB cache entries has the corresponding entry marker set to the first marker value or the second marker value;
means for determining that the entry marker for the TLB cache entry is set to a same value as the context bank marker and, in response, bypassing invalidation for the TLB cache entry and changing the entry marker to a different value than the context bank marker; and
means for determining that the entry marker for the TLB cache entry is set to a different value than the context bank marker and, in response, determining that the TLB cache entry comprises a stale entry and invalidating the TLB cache entry.

9. The system of claim 8, wherein the means for storing the TLB cache entry table comprises a static random access memory (SRAM).

10. The system of claim 8, wherein the TLB cache marking variable comprising the first marker value and the second marker value is implemented with a 1-bit variable.

11. The system of claim 8, wherein the TLB invalidate command comprises one of a global TLB invalidate command and a context-specific TLB invalidate command identifying the translation context bank.

12. The system of claim 8, further comprising:
means for initiating, when the TLB invalidation associated with the translation context bank is not being performed, a cache update command for one of the plurality of TLB cache entries;
means for updating, in response to the cache update command, the one of the plurality of TLB cache entries; and
means for changing the entry marker for the one of the plurality of TLB cache entries to a same value as the context bank marker associated with the translation context bank.

13. The system of claim 8, further comprising:
means for initiating, during the TLB invalidation associated with the translation context bank, a look-up command to one of the plurality of TLB cache entries; and
means for declaring, in response to the look-up command, a cache hit if the entry marker for the one of the plurality of TLB cache entries is set to the same value as the context bank marker.

14. The system of claim 8, further comprising:
means for initiating, during the TLB invalidation associated with the translation context bank, a look-up command to one of the plurality of TLB cache entries, and
means for declaring, in response to the look-up command, a cache miss if the entry marker for the one of the plurality of TLB cache entries is set to the different value than the context bank marker.

15. A computer program embodied in a computer-readable medium and executed by a processor for emulating single-cycle translation lookaside buffer invalidation, the computer program comprising logic configured to:
define a translation lookaside buffer (TLB) cache marking variable comprising a first marker value and a second marker value;
initiate a context bank marker associated with a translation context bank with one of the first marker value and the second marker value;
store in a memory a TLB cache entry table specifying whether each of a plurality of TLB cache entries associated with the translation context bank has a corresponding entry marker set to the first marker value or the second marker value;
in response to a TLB invalidate command associated with the translation context bank, change the context bank marker from the one of the first marker value and the second marker value to the other of the first marker value and the second marker value prior to initiating TLB invalidation; and
during the TLB invalidation associated with the translation context bank:
access the TLB cache entry table to determine whether each of the plurality of TLB cache entries has the corresponding entry marker set to the first marker value or the second marker value;
if the entry marker for the TLB cache entry is set to a same value as the context bank marker, bypass invalidation for the TLB cache entry and change the entry marker to a different value than the context bank marker; and
if the entry marker for the TLB cache entry is set to a different value than the context bank marker, determine that the TLB cache entry comprises a stale entry and invalidate the TLB cache entry.

16. The computer program of claim 15, wherein the memory storing the TLB cache entry table comprises a static random access memory (SRAM).

17. The computer program of claim 15, wherein the TLB cache marking variable comprising the first marker value and the second marker value is implemented with a 1-bit variable.

18. The computer program of claim 15, wherein the TLB invalidate command comprises one of a global TLB invalidate command and a context-specific TLB invalidate command identifying the translation context bank.

19. The computer program of claim 15, further comprising logic configured to:
when the TLB invalidation associated with the translation context bank is not being performed, initiate a cache update command for one of the plurality of TLB cache entries;
in response to the cache update command, update the one of the plurality of TLB cache entries; and
change the entry marker for the one of the plurality of TLB cache entries to a same value as the context bank marker associated with the translation context bank.

20. The computer program of claim 15, further comprising logic configured to:
during the TLB invalidation associated with the translation context bank, initiate a look-up command to one of the plurality of TLB cache entries; and
in response to the look-up command, declare a cache hit if the entry marker for the one of the plurality of TLB cache entries is set to the same value as the context bank marker.

21. The computer program of claim 1, further comprising logic configured to:
during the TLB invalidation associated with the translation context bank, initiate a look-up command to one of the plurality of TLB cache entries; and
in response to the look-up command, declare a cache miss if the entry marker for the one of the plurality of TLB cache entries is set to the different value than the context bank marker.

22. A system comprising:
an application processor comprising a memory management unit (MMU) having a first translation lookaside buffer (TLB);
one or more memory clients having a corresponding system memory management unit (SMMU) comprising a corresponding second TLB; and
a single-cycle TLB invalidation emulator component in communication with the MMU and the SMMU, the single-cycle TLB invalidation emulator component comprising logic configured to:
define a translation lookaside buffer (TLB) cache marking variable comprising a first marker value and a second marker value;
initiate a context bank marker associated with a translation context bank with one of the first marker value and the second marker value;
store in a memory a TLB cache entry table specifying whether each of a plurality of TLB cache entries associated with the translation context bank has a corresponding entry marker set to the first marker value or the second marker value;
in response to a TLB invalidate command associated with the translation context bank, change the context bank marker from the one of the first marker value and the second marker value to the other of the first marker value and the second marker value prior to initiating TLB invalidation; and
during the TLB invalidation associated with the translation context bank;
access the TLB cache entry table to determine whether each of the plurality of TLB cache entries has the corresponding entry marker set to the first marker value or the second marker value;
if the entry marker for the TLB cache entry is set to a same value as the context bank marker, bypass invalidation for the TLB cache entry and change the entry marker to a different value than the context bank marker; and
if the entry marker for the TLB cache entry is set to a different value than the context bank marker, determine that the TLB cache entry comprises a stale entry and invalidate the TLB cache entry.

23. The system of claim 22, wherein the memory storing the TLB cache entry table comprises a static random access memory (SRAM).

24. The system of claim 22, wherein the TLB cache marking variable comprising the first marker value and the second marker value is implemented with a 1-bit variable.

25. The system of claim 22, wherein the TLB invalidate command comprises one of a global TLB invalidate command and a context-specific TLB invalidate command identifying the translation context bank.

26. The system of claim 22, wherein the single-cycle TLB invalidation emulator component further comprises logic configured to:
when the TLB invalidation associated with the translation context bank is not being performed, initiate a cache update command for one of the plurality of TLB cache entries;
in response to the cache update command, update the one of the plurality of TLB cache entries; and
change the entry marker for the one of the plurality of TLB cache entries to a same value as the context bank marker associated with the translation context bank.

27. The system of claim 22, wherein the single-cycle TLB invalidation emulator component further comprises logic configured to:
during the TLB invalidation associated with the translation context bank, initiate a look-up command to one of the plurality of TLB cache entries; and
in response to the look-up command, declare a cache hit if the entry marker for the one of the plurality of TLB cache entries is set to the same value as the context bank marker.

28. The system of claim 22, wherein the single-cycle TLB invalidation emulator component further comprises logic configured to:
during the TLB invalidation associated with the translation context bank, initiate a look-up command to one of the plurality of TLB cache entries; and
in response to the look-up command, declare a cache miss if the entry marker for the one of the plurality of TLB cache entries is set to the different value than the context bank marker.

29. The system of claim 22, wherein the application processor, the one or more memory clients, and the single-cycle TLB invalidation emulator component reside on a system on chip.

30. The system of claim 29, wherein the one or more memory clients comprises one of a display processor and a camera digital signal processor.
